(19) United States
(12) Patent Application Publication
(10) Pub. No.: US 2026/0208288 A1
(43) Pub. Date: Jul. 23, 2026

(54) COMBINED LASER SYSTEM FOR METAL WELDING

(71) Applicant: K2 LASER SYSTEM INC., Suwon-si (KR)

(72) Inventors: Ko Dong PARK, Suwon-si (KR); Shin Kyo KANG, Suwon-si (KR); Joo Ho JUNG, Suwon-si (KR); Yo Han CHO, Suwon-si (KR)

(73) Assignee: K2 LASER SYSTEM INC., Suwon-si (KR)

(21) Appl. No.: 19/453,233

(22) Filed: Jan. 20, 2026

(30) Foreign Application Priority Data
Jan. 20, 2025 (KR) 10-2025-0007923
Jan. 20, 2026 (KR) 10-2026-0010883

(51) Int. Cl. B23K 26/064; B23K 26/06; B23K 26/082; B23K 26/21

(52) U.S. Cl. CPC B23K 26/0643; B23K 26/0613; B23K 26/082; B23K 26/21

(57) ABSTRACT

According to one aspect of the present disclosure, there is provided a combined laser system (100) for metal welding comprising a first light source (110) configured to generate and emit a first laser beam having a relatively short wavelength, a second light source (120) configured to generate and emit a second laser beam having a relatively long wavelength, a first steering mirror (130) configured to reflect the second laser beam and steer an incident angle thereof, an optical combiner (140) configured to combine optical paths of the first laser beam and the second laser beam and form a combined beam, a monitoring mirror (150) configured to reflect the combined beam and transmit a reflected beam that returns after the combined beam is irradiated onto a workpiece and reflected therefrom, a second steering mirror (160) configured to reflect and steer the combined beam in a Y-axis direction, a third steering mirror (170) configured to reflect and steer the combined beam, whose Y-axis position has been steered by the second steering mirror (160), in a X-axis direction, and a scan lens (170) configured to scan the combined beam reflected from the third steering mirror (170) on a working plane.

### CROSS-REFERENCE TO RELATED APPLICATION

This present application claims priority to and the benefit of Korean Patent Application No. 10-2025-0007923 filed Jan. 20, 2025 and Korean Patent Application No. 10-2026-0010883 filed on Jan. 20, 2026, in the Korean Intellectual Property Office, the entire disclosure of which is incorporated herein by reference.

### TECHNICAL FIELD

Embodiments of the present disclosure relate to a laser system, and more particularly, to a combined laser system for metal welding capable of significantly improving welding stability and welding quality for metals having low absorptivity and high reflectivity, such as copper or alloys thereof.

### BACKGROUND

Laser welding technology uses a highly concentrated laser beam as a heat source to melt and join materials, and has advantages such as high speed, high precision, and a minimal heat-affected zone, and thus is utilized in various industrial fields.

Laser welding technology operates on a principle in which a high-energy laser beam is irradiated onto a joint portion of materials to be welded, the material surface absorbs the energy and undergoes a rapid temperature increase to melt and form a molten pool, and then, as cooling and solidification occur, a strong metallic bond is formed. In this process, the focal temperature rises from about 6,000° C. up to 10,000° C.

Laser welding technology allows precise control of a focal point of the laser beam, thereby providing high precision and accuracy, minimizing deformation of surrounding materials due to a minimal heat-affected zone, enabling fast processing speed through efficient heat transfer, and significantly reducing the possibility of contamination because no physical contact is involved.

However, in conventional laser welding technology, when welding metals having low absorptivity and high reflectivity, such as copper or alloys thereof, there are problems in that high power must be used due to low absorptivity, and even when high power is used, various issues in welding stability and welding quality arise due to high reflectivity, such as generation of spatter during welding and even formation of holes or depressions on a material surface.

### SUMMARY

Embodiments of the present disclosure are directed to providing a combined laser system for metal welding that can significantly improve welding stability and welding quality for metals having low absorptivity and high reflectivity, such as copper or alloys thereof, by using a short-wavelength laser for preheating before welding, a long-wavelength laser for welding, and a short-wavelength laser for heat treatment after welding.

According to one aspect of the present disclosure, there is provided a combined laser system for metal welding comprising: a first light source configured to generate and emit a first laser beam having a relatively short wavelength for preheating before welding and heat treatment after welding, a second light source configured to generate and emit a second laser beam having a relatively long wavelength for welding, a first steering mirror configured to reflect the second laser beam and steer an incident angle thereof, an optical combiner configured to combine optical paths of the first laser beam and the second laser beam and form a combined beam, a monitoring mirror configured to reflect the combined beam and transmit a reflected beam that returns after the combined beam is irradiated onto a workpiece and reflected therefrom, a second steering mirror configured to reflect and steer the combined beam in a Y-axis direction, a third steering mirror configured to reflect and steer the combined beam in a X-axis direction, and a scan lens configured to scan the combined beam reflected from the third steering mirror on a working plane, wherein positional deviation between an irradiation region and a designed working region, which occurs when the combined beam passes through the scan lens due to a refractive index difference according to different wavelengths of the first laser beam and the second laser beam, is corrected in the following order: a correction of X-axis and Y-axis positions of the first laser beam, a correction of X-axis and Y-axis positions of the second laser beam, and a correction of X-axis and Y-axis positions of the combined beam.

In some embodiments, the first laser beam is a blue laser having a wavelength of 400 nm to 500 nm, and the second laser beam is an infrared laser having a wavelength of 1,030 nm to 1,080 nm. In some embodiments, the first steering mirror is a fast steering mirror. In some embodiments, the scan lens is an F-theta scan lens of a telecentric F-theta scan lens.

In some embodiments, the of X-axis and Y-axis positions of the first laser beam (00) of the combined beam by Δθx₁ and Δθy₁ along the X-axis and the Y-axis, respectively, and the primary corrected incident angle (θx₁,θy₁) of the combined beam satisfies [Equation 1]:

$$θ {x}_{1} = θ {x}_{0} \pm Δ 0 {x}_{1} ,$$

$$θ {y}_{1} = θ {y}_{0} \pm Δ 0 {y}_{1} .$$

In some embodiments, the correction of Y-axis position is implemented by steering adjustment of the second steering mirror, and the correction of X-axis position is implemented by steering adjustment of the third steering mirror, and the correction of positions modifies distortion of a non-linear curve distorted along the X-axis and the Y-axis, so that the curve becomes a straight line or a substantially straight line along the X-axis and the Y-axis with respected to a center point of the irradiation region of the first laser beam.

In some embodiments, the correction of X-axis and Y-axis positions of the second laser beam is performed, before the combined beam is formed, by modifying the primary corrected incident angle (θx₁,θy₁) of the second laser beam by Δθx₂, Δθy₂ along the X-axis and the Y-axis, respectively, and the secondary corrected incident angle (θ₁) of the second laser beam satisfies [Equation 2]:

$$θ {x}_{2} = θ {x}_{1} \pm Δ 0 {x}_{2} ,$$

$$θ {y}_{2} = θ {y}_{1} \pm Δ 0 {y}_{2} .$$

In some embodiments, the correction of X-axis and Y-axis positions modifies distortion of a non-linear curve distorted along the X-axis and the Y-axis, so that the curve becomes a straight line or a substantially straight line along the X-axis and the Y-axis with respected to the irradiation region of the first laser beam after the primary correction and overlaps the irradiation region of the first laser beam after the primary correction.

In some embodiments, the correction of X-axis and Y-axis positions of the combined beam corrects positional deviation between the designed working region and a irradiation region of the combined beam after the primary correction and the secondary correction, the correction is performed by modifying an overall incident angle of the first steering mirror, the second steering mirror and the third steering mirror by Δθx₃, Δθy₃ along the X-axis and the Y-axis, respectively, and the final incident angle (θx₃,θy₃) of the combined beam satisfies [Equation 3]:

$$θ {x}_{3} = θ {x}_{2} \pm Δ 0 {x}_{3} ,$$

$$θ {y}_{3} = θ {y}_{2} \pm Δ 0 {y}_{3} .$$

In some embodiments, the position modification of the irradiation region of the combined beam along the X-axis and the Y-axis is implemented by simultaneous steering adjustment of the first steering mirror, the second steering mirror, and the third steering mirror, and the irradiation region of the combined beam approaches the designed working region and becomes coincident therewith so as to overlap the designed working region.

Embodiments of the present disclosure can provide a combined laser system for metal welding that can significantly improve welding stability and welding quality for metals having low absorptivity and high reflectivity, such as copper or alloys thereof, by using a blue laser having a short wavelength of 400 nm to 500 nm for preheating before welding, an infrared laser having a long wavelength of 1,030 nm to 1,080 nm for welding, and a blue laser having a short wavelength of 400 nm to 500 nm for heat treatment after welding.

### BRIEF DESCRIPTION OF THE DRAWINGS

FIG. 1 is a schematic diagram illustrating a combined laser system for metal welding according to the present disclosure.

FIG. 2 is a diagram exemplarily illustrating an irradiation region when the combined beam of FIG. 1 is irradiated onto a work plane at an initial incident angle.

FIG. 3 is a diagram exemplarily illustrating an irradiation region when the combined beam of FIG. 2 is irradiated onto a work plane at a primary corrected incident angle.

FIG. 4 is a diagram exemplarily illustrating an irradiation region when the combined beam of FIG. 3 is irradiated onto a work plane at a secondary corrected incident angle.

FIG. 5 is a diagram exemplarily illustrating an irradiation region when the combined beam of FIG. 4 is irradiated onto a work plane at a final corrected incident angle.

### DETAILED DESCRIPTION

The present disclosure was developed to be suitable for sliding metals having low absorptivity and high reflectivity, such as copper or alloys thereof. By introducing a mechanical concept in which the energy absorptivity of copper or a copper alloy varies depending on temperature, a blue laser having a short wavelength of 400 nm to 500 nm is used for preheating before welding, an infrared laser having a long wavelength of 1,030 nm to 1,080 nm is used for welding, and the blue laser having the short wavelength of 400 nm to 500 nm is used for heat treatment after welding.

Here, in the preheating step before welding, the blue laser is irradiated onto the surface of the copper or copper alloy material to be welded for a predetermined time until the absorptivity of the material reaches a temperature at which it becomes 65% or more, thereby increasing the surface temperature of the material. In addition, in the welding step, the infrared laser is irradiated for an additional time into a molten pool that has been stably formed in the preheating step, thereby forming a keyhole and performing the welding operation. Finally, in the heat treatment step after welding, the blue laser is further irradiated for an additional time to control the cooling rate of the welded region, thereby making solidification uniform and allowing pores to be discharged.

In order to use two laser beams having different wavelengths in a single path, the blue laser having the short wavelength of 400 nm to 500 nm and the infrared laser having the long wavelength of 1,030 nm to 1,080 nm are combined into one path. In addition, each of the laser beams whose paths are combined are steered in a planar position, that is, along the X-axis and Y-axis, and then passes through a scan lens to be irradiated onto the work plane.

In this process, due to the different wavelengths of the respective laser beams whose paths are combined, a difference in refractive index occurs when passing through the scan lens. As a result, each of the laser beams whose paths are combined is irradiated onto different planar positions or planar regions, respectively, thereby causing positional deviation. Correction of this positional deviation is performed in the following order: a correction of X-axis and Y-axis positions of the first laser beam, a correction of X-axis and Y-axis positions of the second laser beam, and a correction of X-axis and Y-axis positions of the combined beam.

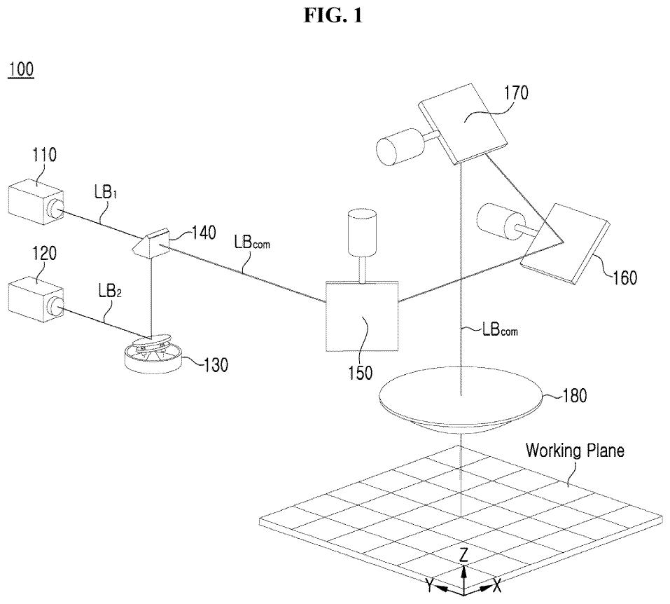

Hereinafter, a combined laser system for metal welding according to the present disclosure will be described in detail with reference to the accompanying drawings. FIG. 1 is a schematic diagram illustrating a combined laser system for metal welding according to the present disclosure.

Referring to FIG. 1, a combined laser system (100) for metal welding according to the present disclosure comprises a first light source (110), a second light source (120), a first steering mirror (130), an optical combiner (140), a monitoring mirror (150), a second steering mirror (160), a third steering mirror (170), and a scan lens (170).

The first light source (110) generates and emits a first laser beam (LB1) having a relatively short wavelength, which is used for preheating before welding and heat treatment after welding, and a blue laser having a short wavelength of 400 nm to 500 nm is preferably used therefor.

The second light source (120) generates and emits a second laser beam (LB2) having a relatively long wavelength, which is used for welding, and an infrared laser having a long wavelength of 1,030 nm to 1,080 nm is preferably used therefor.

The first steering mirror (130) reflects the second laser beam (LB2) emitted from the second light source (120) to steer an incident angle thereof. Preferably, a fast steering mirror (FSM) capable of rapidly adjusting a minute mirror angle to control a path of the laser beam and accurately positioning the laser beam at a desired location by correcting errors is used. The fast steering mirror can adjust the position of the laser beam by rapidly implementing minute angular variations on the order of several u rad.

The optical combiner (140) combines paths of the first laser beam (LB1) and the second laser beam (LB2) into one path. The optical combiner (140) transmits the first laser beam (LB1) emitted from the first light source (110), while reflecting the second laser beam (LB2) emitted from the second light source (120) and reflected by the first steering mirror (130), thereby forming a combined beam (LBcom) positioned on the same axis.

The monitoring mirror (150) reflects the combined beam (LBcom) and transmits a reflected beam that returns after the combined beam is irradiated onto a workpiece and reflected therefrom. The transmitted reflected beam is directed to a monitoring device (not shown) to monitor an operating state of a work plane.

The second steering mirror (160) reflects the combined beam (LBcom) reflected from the monitoring mirror (150) while steering the beam to a desired position along a Y-axis. Preferably, a Y-axis galvanometer mirror may be used.

The third steering mirror (170) reflects the combined beam (LBcom) while steering the beam to a desired position along an X-axis. Preferably, an X-axis galvanometer mirror may be used.

The scan lens (180) scans the combined beam (LBcom) reflected from the third steering mirror (170) onto the work plane. Preferably, an F-theta scan lens may be used to maintain a constant focus over an entire work plane. In addition, a telecentric F-theta scan lens may also preferably be used so that the combined beam (LBcom) is irradiated substantially perpendicular to the entire work plane.

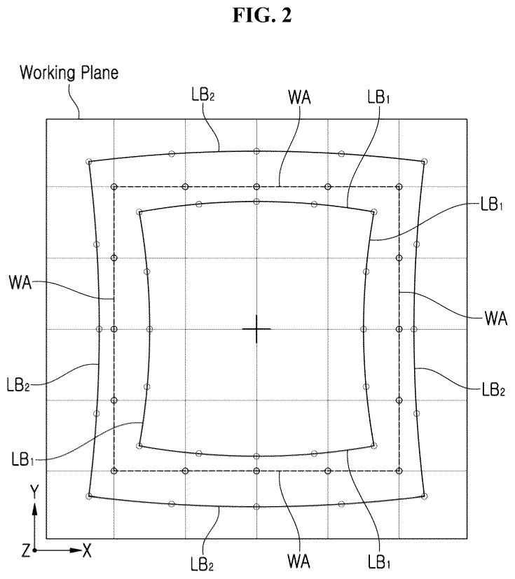

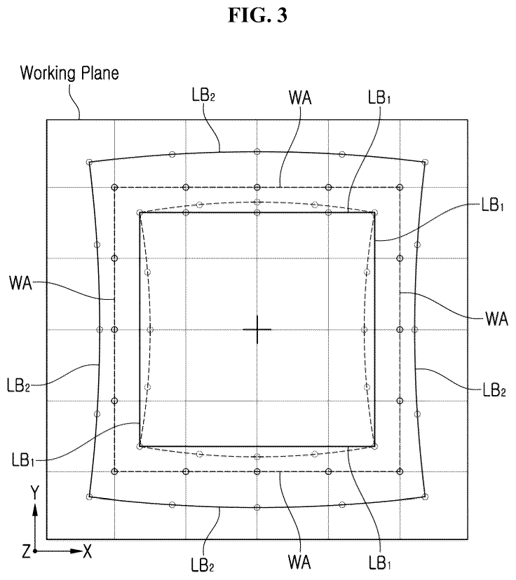

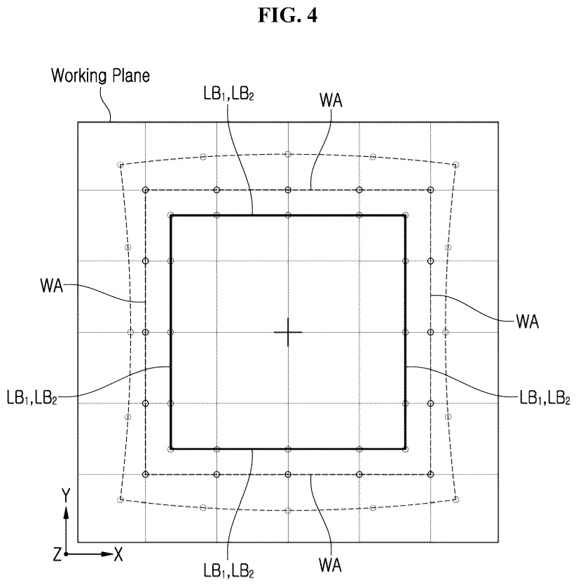

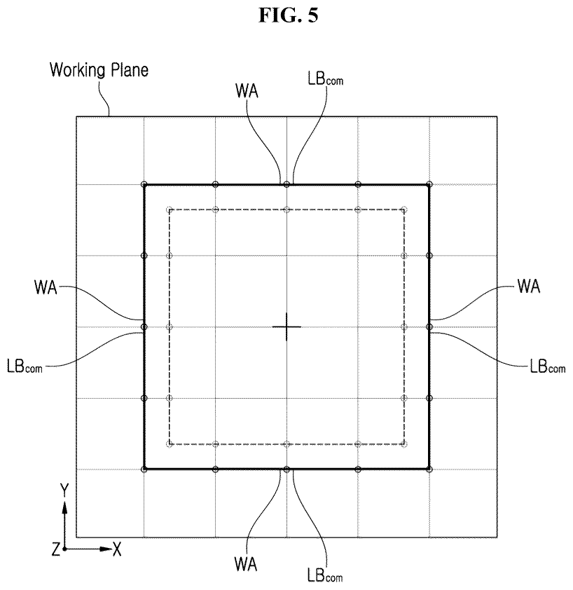

Next, an operation of the combined laser system (100) for metal welding according to the present invention described above will be explained. FIG. 2 is a diagram exemplarily illustrating an irradiation region when the combined beam of FIG. 1 is irradiated onto a work plane at an initial incident angle. FIG. 3 is a diagram exemplarily illustrating an irradiation region when the combined beam of FIG. 2 is irradiated onto a work plane at a primary corrected incident angle. FIG. 4 is a diagram exemplarily illustrating an irradiation region when the combined beam of FIG. 3 is irradiated onto a work plane at a secondary corrected incident angle. FIG. 5 is a diagram exemplarily illustrating an irradiation region when the combined beam of FIG. 4 is irradiated onto a work plane at a final corrected incident angle.

For purposes of explanation, each drawing shows coordinate axes in which an X-axis and a Y-axis form a plane and a Z-axis is orthogonal to the plane. Further, for purposes of explanation, the work plane (WA) is positioned in a first quadrant with respect to origin on a plane defined by the X-axis and the Y-axis, and a continuously formed work plane (WA) is represented by points at specific positions and dotted lines connecting the respective points. In addition, the first laser beam is denoted as “LB1,”, the second laser beam is denoted as “LB2,”, and the combined beam is denoted as “LBcom.”

First, as illustrated in FIG. 2, a combined beam (LBcom), in which the first laser beam (LB1) and the second laser beam (LB2) are combined, enters at an initial incident angle (00), passes through the scan lens (180), and is then refracted and irradiated onto a work plane. In this case, the first laser beam (LB1) having a relatively short wavelength has a relatively high refractive index, so that an irradiation region thereof is formed inside a designed work region (WA) indicated by dotted lines, whereas the second laser beam (LB2) having a relatively long wavelength has a relatively low refractive index, so that an irradiation region thereof is formed outside the designed work region (WA), thereby causing positional deviations along the X-axis and the Y-axis.

Next, in order to correct the positional deviation, as illustrated in FIG. 3, positional deviations of the first laser beam (LB1) along the X-axis and the Y-axis are primarily corrected. This correction is implemented by modifying an initial incident angle (θ₀) of the combined beam by Δθx₁ and Δθy₁ along the X-axis and the Y-axis, respectively, and the primary corrected incident angle (θx₁,θy₁) of the combined beam satisfies [Equation 1]:

$$θ {x}_{1} = θ {x}_{0} \pm Δ 0 {x}_{1} ,$$

$$θ {y}_{1} = θ {y}_{0} \pm Δ 0 {y}_{1} .$$

The correction of Y-axis position is implemented by steering adjustment of the second steering mirror (160), and the correction of X-axis position is implemented by steering adjustment of the third steering mirror (170). The Y-axis position modification and the X-axis position modification may be performed in any order. The correction of positions modifies distortion of a non-linear curve distorted along the X-axis and the Y-axis, so that the curve becomes a straight line or a substantially straight line along the X-axis and the Y-axis with respected to a center point (+) of the irradiation region of the first laser beam. For clarity of illustration, the irradiation area of the first laser beam (LB1) before the correction is represented by a dotted line, whereas the irradiation area after the correction is represented by a solid line.

The correction of X-axis and Y-axis positions of the first laser beam corrects the positional deviation of the first laser beam (LB1) along the X-axis and the Y-axis. The correction is implemented by jointly adjusting the incident angle of the combined beam (LBcom) through the steering adjustment of the second steering mirror (160) and the third steering mirror (170), unintended positional changes of the second laser beam (LB2) along the X-axis and the Y-axis may occur.

Next, in order to perform additional correction of positional deviation, as illustrated in FIG. 4, positional deviations of the second laser beam (LB2) along the X-axis and the Y-axis are secondarily corrected. The correction is implemented by reflecting the positional changes of the second laser beam (LB2) that may be occurred unintentionally in FIG. 3, and the correction is performed, before the combined beam is formed, by modifying the primary corrected incident angle (θx₁,θy₁) of the second laser beam by Δθx₂, Δθy₂ along the X-axis and the Y-axis, respectively. The secondary corrected incident angle (θx₂,θy₂) of the second laser beam (LB2) satisfies [Equation 2]:

$$θ {x}_{2} = θ {x}_{1} \pm Δ 0 {x}_{2} ,$$

$$θ {y}_{2} = θ {y}_{1} \pm Δ 0 {y}_{2} .$$

The correction of X-axis and Y-axis positions is implemented by steering adjustment of the first steering mirror (130). The correction of positions modifies distortion of a non-linear curve distorted along the X-axis and the Y-axis, so that the curve becomes a straight line or a substantially straight line along the X-axis and the Y-axis with respected to the irradiation region of the first laser beam after the primary correction and overlaps the irradiation region of the first laser beam after the primary correction. For clarity of illustration, the irradiation area of the second laser beam (LB2) before the correction is represented by a dotted line, whereas the irradiation area after the correction is represented by a solid line overlapped with the irradiation area of the first laser beam (LB1) after the primary correction.

Finally, in order to match the irradiation area of the combined beam (LBcom) whose incident angle has been primarily and secondarily corrected as described above, with the designed working area (WA), a final correction of the positional deviation of the irradiation area of the combined beam (LBcom) with respect to the working area (WA) is performed as illustrated in FIG. 5. This correction of X-axis and Y-axis positions of the combined beam is performed by modifying an overall incident angle of the first steering mirror (130), the second steering mirror (160) and the third steering mirror (170) by Δθx₃, Δθy₃ along the X-axis and the Y-axis, respectively, and the final incident angle (θx₃,θy₃) of the combined beam satisfies [Equation 3]:

$$θ {x}_{3} = θ {x}_{2} \pm Δ 0 {x}_{3} ,$$

$$θ {y}_{3} = θ {y}_{2} \pm Δ 0 {y}_{3} .$$

The position modification of the irradiation region of the combined beam (LBcom) along the X-axis and the Y-axis is implemented by simultaneous steering adjustment of the first steering mirror (130), the second steering mirror (160), and the third steering mirror (170). The irradiation area of the combined beam (LBcom), which was represented by a solid line in FIG. 4, approaches and coincides with the designed working area (WA), thereby overlapping therewith. For clarity of illustration, the irradiation area of the combined beam (LBcom) before the correction is represented by a dotted line, whereas the irradiation area after the correction is represented by a solid line.

While the combined laser system for metal welding according to the present invention has been described above, various changes, modifications and alternations may be made by those skilled in the art within the scope without departing from the spirit and scope of the present disclosure.

1. A combined laser system (100) for metal welding, comprising:
a first light source (110) configured to generate and emit a first laser beam having a relatively short wavelength for preheating before welding and heat treatment after welding;
a second light source (120) configured to generate and emit a second laser beam having a relatively long wavelength for welding;
a first steering mirror (130) configured to reflect the second laser beam and steer an incident angle thereof;
an optical combiner (140) configured to combine optical paths of the first laser beam and the second laser beam and form a combined beam;
a second steering mirror (160) configured to reflect and steer the combined beam in a Y-axis direction;
a third steering mirror (170) configured to reflect and steer the combined beam in an X-axis direction; and
a scan lens (170) configured to scan the combined beam reflected from the third steering mirror (170) on a working plane,
wherein positional deviation between an irradiation region and a designed working region, which occurs when the combined beam passes through the scan lens (180) due to a refractive index difference according to different wavelengths of the first laser beam and the second laser beam, is corrected in the following order: a correction of X-axis and Y-axis positions of the first laser beam, a correction of X-axis and Y-axis positions of the second laser beam, and a correction of X-axis and Y-axis positions of the combined beam.

2. The combined laser system (100) for metal welding according to claim 1,
wherein the first laser beam is a blue laser having a wavelength of 400 nm to 500 nm, and the second laser beam is an infrared laser having a wavelength of 1,030 nm to 1,080 nm.

3. The combined laser system (100) for metal welding according to claim 1,
wherein the first steering mirror (130) is a fast steering mirror.

4. The combined laser system (100) for metal welding according to claim 1,
wherein the scan lens (180) is an F-theta scan lens or a telecentric F-theta scan lens.

5. The combined laser system (100) for metal welding according to claim 1,
wherein the correction of X-axis and Y-axis positions of the first laser beam is performed by modifying an initial incident angle (00) of the combined beam by Δθx₁ and Δθy₁ along the X-axis and the Y-axis, respectively, and the primary corrected incident angle (θx₁,θy₁) of the combined beam satisfies [Equation 1]:
$$θ {x}_{1} = θ {x}_{0} \pm Δ 0 {x}_{1} ,$$
$$θ {y}_{1} = θ {y}_{0} \pm Δ 0 {y}_{1} .$$

6. The combined laser system (100) for metal welding according to claim 5,
wherein the correction of Y-axis position is implemented by steering adjustment of the second steering mirror (160), and the correction of X-axis position is implemented by steering adjustment of the third steering mirror (170), and
wherein the correction of positions modifies distortion of a non-linear curve distorted along the X-axis and the Y-axis, so that the curve becomes a straight line or a substantially straight line along the X-axis and the Y-axis with respected to a center point of the irradiation region of the first laser beam.

7. The combined laser system (100) for metal welding according to claim 5,
wherein the correction of X-axis and Y-axis positions of the second laser beam is performed, before the combined beam is formed, by modifying the primary corrected incident angle (θ₁) of the second laser beam by Δθx₂, Δθy₂ along the X-axis and the Y-axis, respectively, and
wherein the secondary corrected incident angle (θx₂,θy₂) of the second laser beam satisfies [Equation 2]:
$$θ {x}_{2} = θ {x}_{1} \pm Δ 0 {x}_{2} ,$$
$$θ {y}_{2} = θ {y}_{1} \pm Δ 0 {y}_{2} .$$

8. The combined laser system (100) for metal welding according to claim 7,
wherein the correction of X-axis and Y-axis positions is implemented by steering adjustment of the first steering mirror (130), and
wherein the correction of positions modifies distortion of a non-linear curve distorted along the X-axis and the Y-axis, so that the curve becomes a straight line or a substantially straight line along the X-axis and the Y-axis with respected to the irradiation region of the first laser beam after the primary correction and overlaps the irradiation region of the first laser beam after the primary correction.

9. The combined laser system (100) for metal welding according to claim 7,
wherein the correction of X-axis and Y-axis positions of the combined beam corrects positional deviation between the designed working region and an irradiation region of the combined beam after the primary correction and the secondary correction,
wherein the correction of X-axis and Y-axis positions of the combined beam is performed by modifying an overall incident angle of the first steering mirror (130), the second steering mirror (160) and the third steering mirror (170) by Δθx₃, Δθy₃ along the X-axis and the Y-axis, respectively, and
wherein the final incident angle (θx₃,θy₃) of the combined beam satisfies [Equation 3]:
$$θ {x}_{3} = θ {x}_{2} \pm Δ 0 {x}_{3} ,$$
$$θ {y}_{3} = θ {y}_{2} \pm Δ 0 {y}_{3} .$$

10. The combined laser system (100) for metal welding according to claim 9,
wherein the position modification of the irradiation region of the combined beam along the X-axis and the Y-axis is implemented by simultaneous steering adjustment of the first steering mirror (130), the second steering mirror (160), and the third steering mirror (170), and
wherein the irradiation region of the combined beam approaches the designed working region and becomes coincidence therewith so as to overlap the designed working region.
